(19) United States
(12) Patent Application Publication
(10) Pub. No.: US 2023/0372193 A1
(43) Pub. Date: Nov. 23, 2023

(54) CONFIGURABLE MASSAGE DEVICE

(71) Applicants: Mark Erb, Menomonie, WI (US); Randy Webb, Boyceville, WI (US)

(72) Inventors: Mark Erb, Menomonie, WI (US); Randy Webb, Boyceville, WI (US)

(21) Appl. No.: 18/305,894

(22) Filed: Apr. 24, 2023

Related U.S. Application Data
(63) Continuation-in-part of application No. 17/749,631, filed on May 20, 2022.

(51) Int. Cl. A61H 23/02

(52) U.S. Cl. CPC A61H 23/02; A61H 2201/1654; A61H 2205/12; A61H 2205/10

(57) ABSTRACT

A configurable self-massaging device. The device may comprise a base component having a leg support pole extending from the base component at an angle. The device may further comprise a main pole extending vertically from the base component. The device may further comprise one or more massage components. Each massage component may comprise a cushion, a vibration component attached to the cushion, wherein actuating the vibration component may cause vibration of the cushion, and an attachment component configured to secure the massage component to a point on a pole. A massage component attached to the main pole may allow for massaging of a user's hands, wrists, back, buttocks, chest, face, neck, and head. A massage component attached to the leg support pole may allow for massaging of a user's legs and feet.

### CROSS-REFERENCES TO RELATED APPLICATIONS

This application is a continuation-in-part and claims benefit of U.S. patent application Ser. No. 17/749,631, filed May 20, 2022, the specification of which is incorporated herein in their entirety by reference.

### FIELD OF THE INVENTION

The present invention is directed to devices for self-application of massage therapy to various parts of a user's body.

### BACKGROUND OF THE INVENTION

Massage therapy involves the manipulation of various soft tissues in the body and has been found to have massive benefits for stress relief, pain relief, relief of muscle tension, overall relaxation, and even immune function. This is especially helpful for people who experience muscle pain at an intensity that prevents them from moving normally throughout the day (i.e. older people). The people that require massage therapy most generally require the help of others to provide this, but this would typically require them to invite a massage therapist into their home since their lack of movement capabilities may prevent them from leaving their houses on their own. This can be costly and uncomfortable for the recipient, however. Thus, there exists a present need for massage therapy devices that allow for easily accessible massages for people with a low range of movement.

### BRIEF SUMMARY OF THE INVENTION

It is an objective of the present invention to provide devices that allow for the self-application of massage therapy to various parts of a user's body, as specified in the independent claims. Embodiments of the invention are given in the dependent claims. Embodiments of the present invention can be freely combined if they are not mutually exclusive.

In some aspects, the present invention features a configurable self-massaging device. In some embodiments, the device may comprise a base component having a leg support pole extending from the base component at an angle relative to the base component. The device may further comprise a main pole extending vertically from the base component. The device may further comprise one or more JeanieTM massage components. Each JeanieTM massage component may comprise a cushion, a vibration component attached to the cushion, wherein actuating the vibration component may cause vibration of the cushion, and an attachment component configured to secure the massage component to a point on a pole. A massage component attached to the main pole may allow for massaging of a user's hands, wrists, back, buttocks, chest, face, neck, and head. A massage component attached to the leg support pole may allow for massaging of a user's legs and feet.

In some embodiments, a rotation component (150) is coupled to the main pole (120). In some embodiments, the massage component (130) attached to the main pole (120) can be attached to the rotation component (150) by a rotational attachment component such that said massage component (130) is configured to rotate on an axis defined by the rotational attachment component.

One of the unique and inventive technical features of the present invention is the configurability of massage component positions on a skeleton structure. Without wishing to limit the invention to any theory or mechanism, it is believed that the technical feature of the present invention advantageously provides for self-massaging of various body parts in a plurality of different ways, allowing the user to configure the device based on their comfort and preferences. None of the presently known prior references or work has the unique inventive technical feature of the present invention.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows the configurable self-massaging device of the present invention with no massage components attached.

FIG. 2A shows a massage component of the device of the present invention.

FIG. 2B shows a dual massage component of the device of the present invention.

FIG. 2C shows a side view of a dual massage component of the device of the present invention.

FIG. 3A shows the configurable self-massaging device of the present invention with a massage component attached to the leg support pole for leg or foot massage.

FIG. 3B shows the configurable self-massaging device of the present invention with massage components attached to the leg support pole and the auxiliary pole for simultaneous leg and foot massage.

FIG. 4 shows the configurable self-massaging device of the present invention in use in a back massage configuration with a massage component attached to the main pole.

FIG. 5A shows a front view of the configurable self-massaging device of the present invention with multiple massage components attached to the main pole for simultaneous massaging of various body parts (e.g. back, buttocks, neck, chest, face, etc.).

FIG. 5B shows a side view of the configurable self-massaging device of the present invention with multiple massage components attached to the main pole for simultaneous massaging of various body parts.

FIG. 6 shows a view of the configurable self-massaging device of the present invention with a hand support pole in use for massaging wrists of a user.

FIG. 7 shows an exploded view of the components of the device of the present invention with all removable components shown separated from each other.

FIGS. 8A-8C show an embodiment of the configurable self-massaging device of the present invention with a rotation component. FIG. 8A shows a front view of the rotating embodiment of the present invention. FIG. 8B shows a first top view of the rotating embodiment of the present invention. FIG. 8C shows a second top view of the rotating embodiment of the present invention.

### DETAILED DESCRIPTION OF THE INVENTION

Following is a list of elements corresponding to a particular element referred to herein:
100 configurable self-massaging device
110 base component
115 leg support pole
117 auxiliary pole
120 main pole
130 massage component
131 cushion
132 vibration component
133 attachment component
140 hand support pole
150 rotation component

In some embodiments, the present invention comprises a configurable self-massaging device (100). The device (100) may comprise a base component (110), a main pole (120) extending vertically from the base component (110), and one or more Jeanie™ vibrating massage components, each vibrating massage component (130) configured to be attached to a point on a pole.

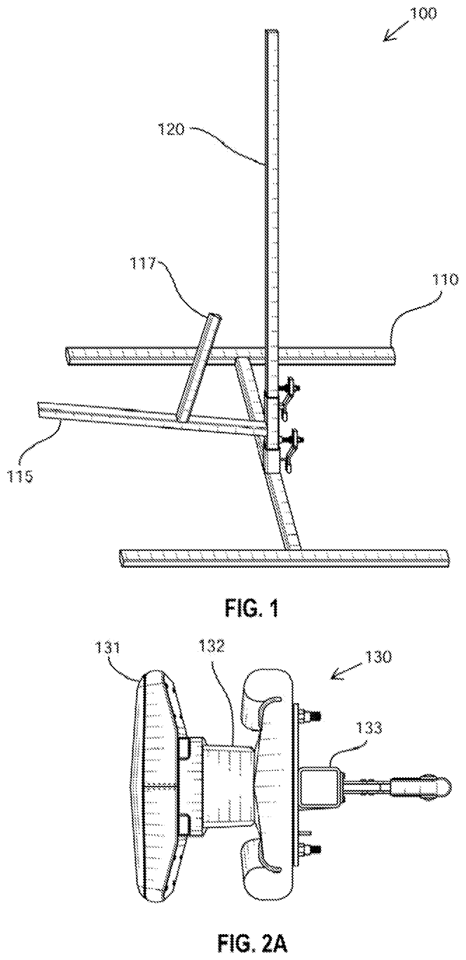

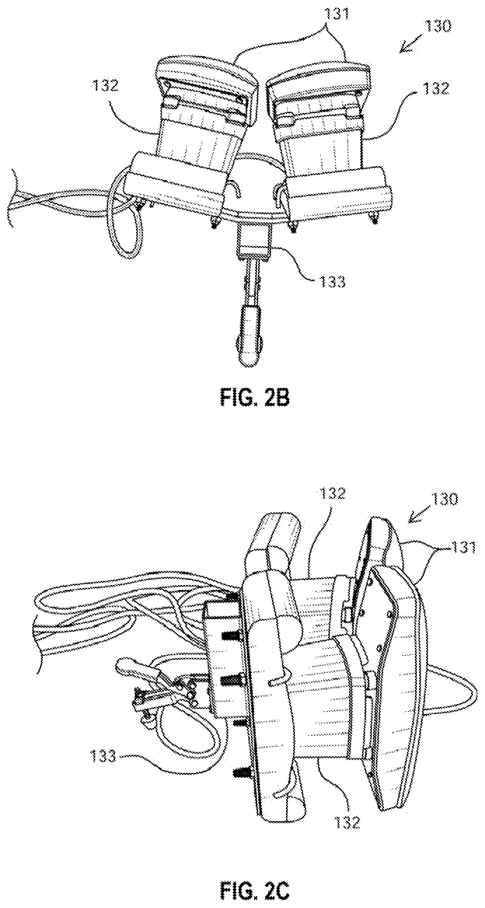

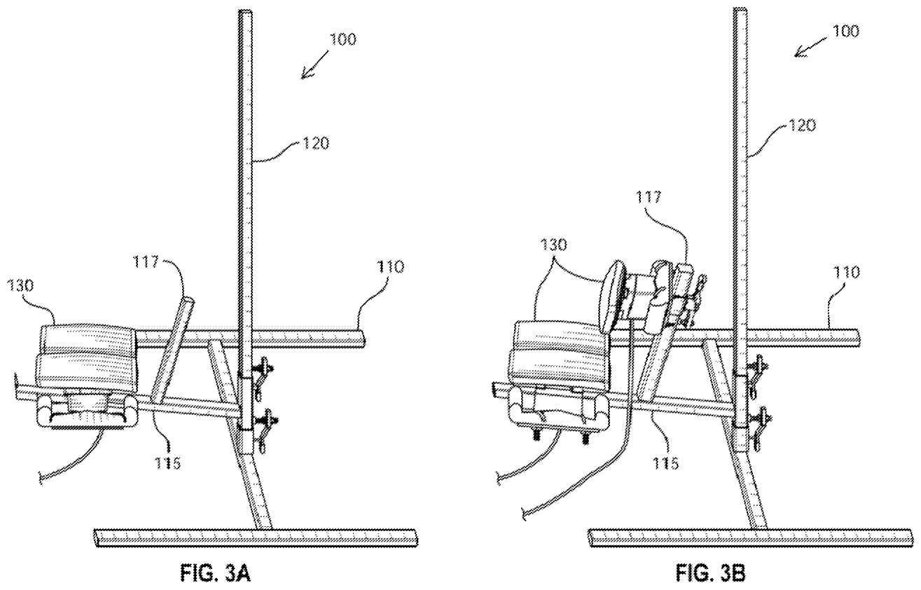

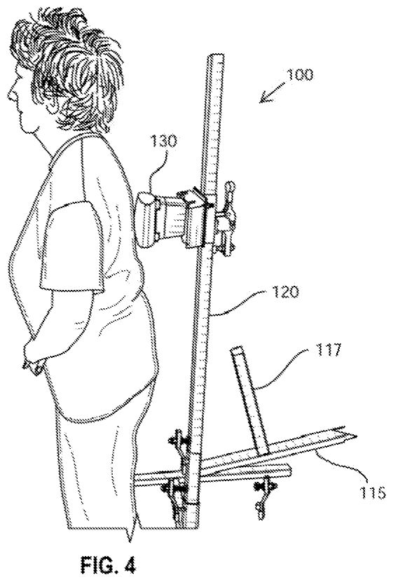

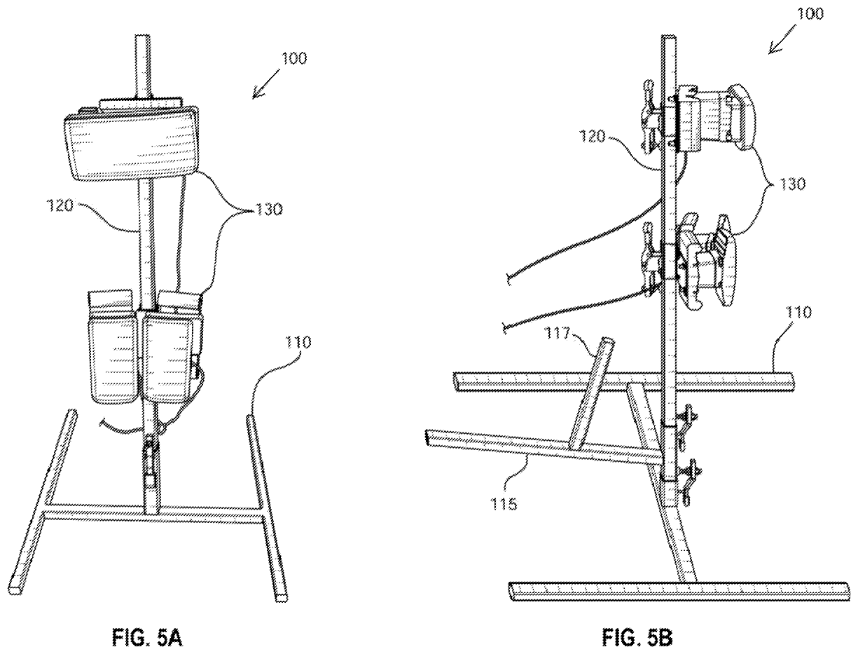

Referring now to FIGS. 1-5B, the present invention features a configurable self-massaging device (100). In some embodiments, the device (100) may comprise a base component (110) having a leg support pole (115) extending from the base component (110) at an angle relative to the base component (110). The device (100) may further comprise a main pole (120) extending vertically from the base component (110). In some embodiments, the main pole (120) may be removably disposed within the base component (110). The device (100) may further comprise one or more massage components. Each massage component (130) may comprise a cushion (131), a vibration component (132) attached to the cushion (131), wherein actuating the vibration component (132) may cause vibration of the cushion (131), and an attachment component (133) configured to secure the massage component (130) to a point on a pole. A massage component (130) attached to the main pole (120) may allow for massaging of a user's hands, wrists, back, buttocks, chest, face, neck, and head. A massage component (130) attached to the leg support pole (115) may allow for massaging of a user's legs and feet.

Each massage component may further comprise a power component for providing power to the vibrating component. This power component may comprise a wired connection to a wall outlet, or a self-contained power source such as a battery. Each massage component may additionally comprise an actuation component allowing the user to turn the vibration component (132) on and off. This actuation component may comprise a button, a switch, or any other structure that allows for actuation. Each attachment component (133) may comprise a clamp component. The clamp may comprise a screw that can be loosened or tightened. While the screw is loosened, the clamp may be freely moved along a pole. While the screw is tightened, the clamp may hold the massage component in place on the pole. In some embodiments, the massage components can be freely removed and added to the various poles of the device, thus providing a wide plurality of configurations of massage component positions in the present invention. Additionally, each massage component (130) may comprise a massage holder for holding all components in place and connecting the massage component (130) to the device.

In some embodiments, each massage component (130) may further comprise an additional cushion and an additional vibration component (132) attached to the additional cushion. Actuating the additional vibration component (132) may cause vibration of the additional cushion. In other embodiments, the additional cushion may be vibrated by the initial vibrating component. The dual cushion design may be useful for hand, wrist, leg, and foot massage. In some embodiments, the device (100) comprises a hand support pole removably attached to the main pole (120). The hand support pole may horizontally extend from the main pole (120). In some embodiments, each massage component (130) may further comprise a cushion cover configured to encapsulate the cushion (131).

In some embodiments, the main pole (120) may be telescopically and removably attached to the base component (110). The main pole (120) may be locked in position by a screw or peg suspending it in place within the base component (110). In other embodiments, the main pole (120) may be locked in position by a toggle lock. Additionally, the leg support pole (115) may be removably disposed on the main pole (120) and locked in place by a toggle lock. Additionally, the massage components may be locked in place on any pole by a toggle lock. In some embodiments, the entire device (100) may be capable of being disassembled for storage.

The material of the base component (110) may comprise metal. The base component (110) may be H-shaped, X-shaped, or any other shape that provides stability to the device (100). The material of the main pole (120) may also comprise metal. In other embodiments, either or both of these components may comprise any rigid material. The leg support pole (115) may further comprise an auxiliary pole (117) extending from the leg support pole (115) at a right angle relative to the leg support pole (115). In other embodiments, the auxiliary pole (117) may extend from the leg support pole (115) at a 45 to 100 degree angle relative to the leg support pole (115). The auxiliary pole (117) may be suitable for different foot or leg massage configurations. The angle that the leg support pole (115) extends from the base component (110) may be 30 to 60 degrees relative to the base component (110).

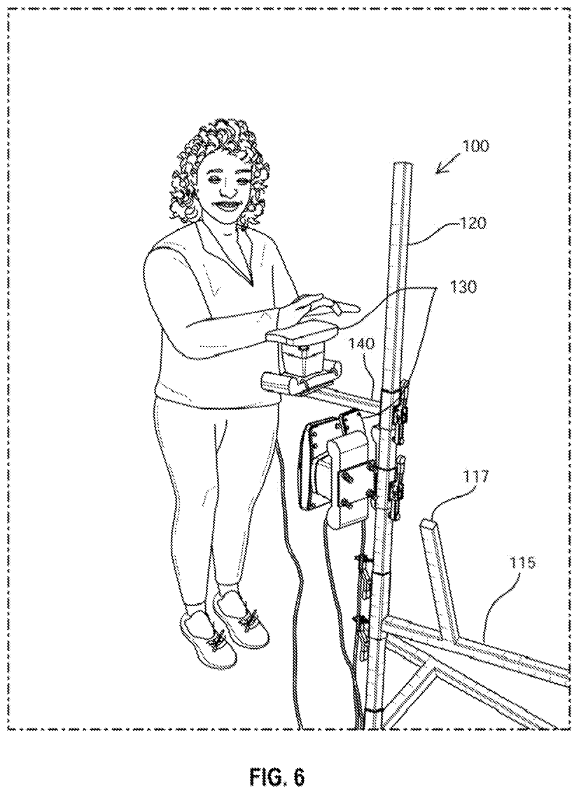

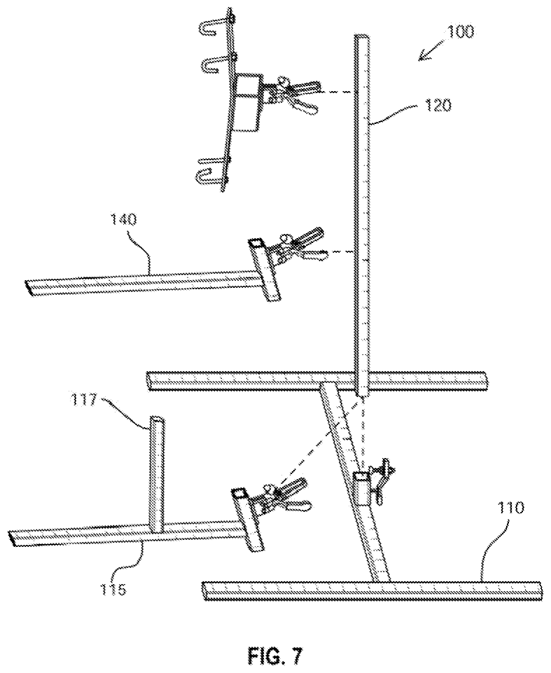

In some embodiments, the device (100) may further comprise a hand support pole (140) removably disposed on the main pole (120), extending at a 90 to 115 degree angle from the main pole (120). The hand support pole (140) may be suitable for massaging a user's wrists and hands, as depicted in FIG. 6. The hand support pole (140) may be locked in place on the main pole (120) by a toggle lock.

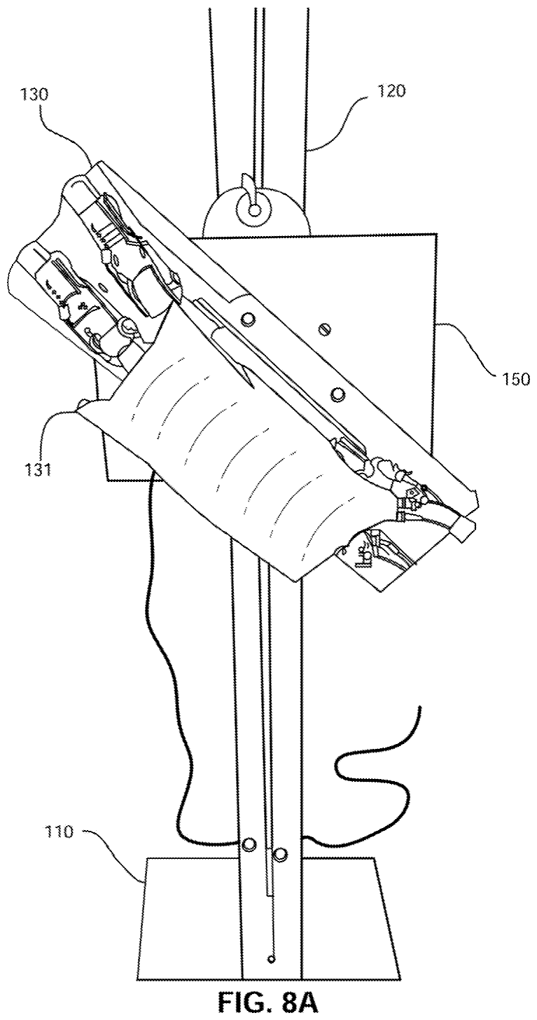

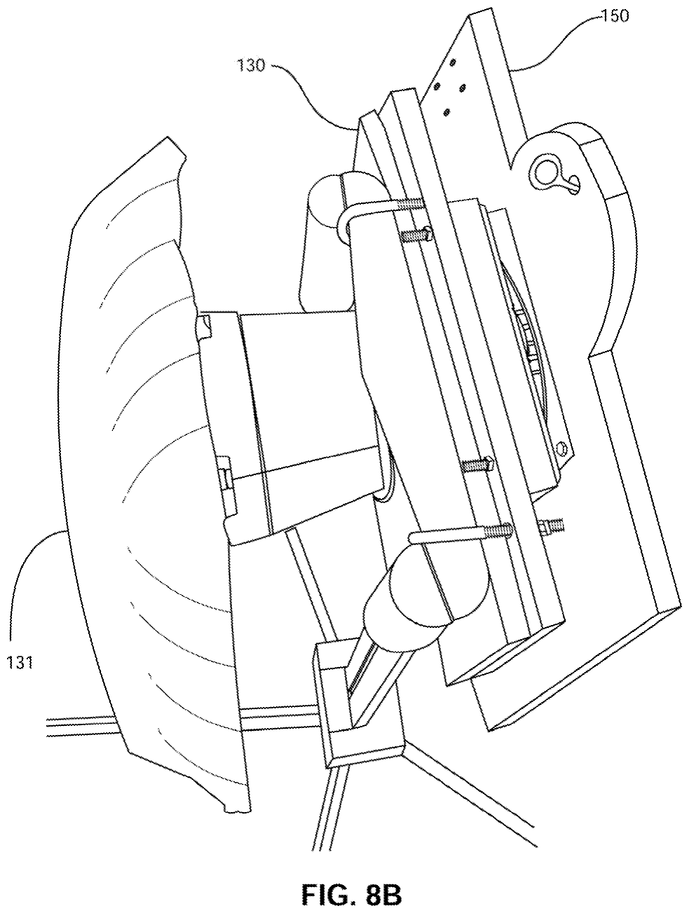

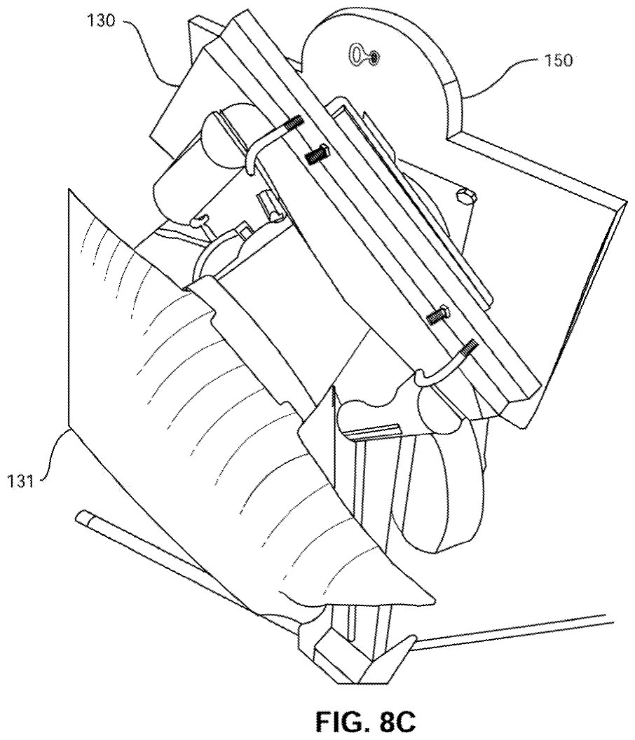

In some embodiments, the device (100) may further comprise a rotation component (150) coupled to the main pole (120). The massage component (130) may be attached to the rotation component (150) by a rotational attachment component such that the massage component (130) is configured to rotate on an axis defined by the rotational attachment component. The rotation component (150) may comprise a board attached to the main pole (120), as depicted in FIG. 8. In some embodiments, the rotational attachment component may comprise a peg attached to the board and a hole configured to fit the peg may be disposed on the massage component (130). In other embodiments, the rotational attachment component may comprise a peg attached to the massage component (130) and a hole configured to fit the peg may be disposed on the board. In some embodiments, the peg may be configured to rotate, allowing for free rotation of the rotation component (150). In some embodiments, the peg may have a circular cross-section, thus allowing the rotation component (150) to rotate around the peg. In some embodiments, the rotational attachment component may comprise a ball joint. The rotation component (150) may allow for added configurability of the device (100), as the rotation component (150) stays fixed in place unless actively rotated by the user. In some embodiments, as shown in FIGS. 8A-8C, the massage component (130) may comprise J-bolts or straps to attach the massage component (130) to the rotation component (140).

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A configurable self-massaging device (100) comprising:
a. a base component (110);
b. a leg support pole (115) extending from the base component (110) at an angle relative to the base component (110);
c. a main pole (120) extending vertically from the base component (110);
d. one or more massage components (130), each massage component (130) comprising:
i. a cushion (131);
ii. a vibration component (132) attached to the cushion (131), wherein actuating the vibration component (132) causes vibration of the cushion (131); and
iii. an attachment component (133) configured to secure the massage component (130) to a point on a pole;
wherein a massage component (130) attached to the main pole (120) allows for massaging of a user's hands, wrists, back, buttocks, chest, face, neck, and head;
wherein a massage component (130) attached to the leg support pole (115) allows for massaging of a user's legs and feet; and
e. a rotation component (150) coupled to the main pole (120), wherein the massage component (130) attached to the main pole (120) is attached to the rotation component (150) by a rotational attachment component such that the massage component (130) attached to the main pole (120) is configured to rotate on an axis defined by the rotational attachment component.

2. The device (100) of claim 1, wherein each massage component (130) further comprises:
a. an additional cushion; and
b. an additional vibration component attached to the additional cushion, wherein actuating the additional vibration component causes vibration of the additional cushion.

3. The device (100) of claim 1, wherein the main pole (120) is telescopically attached to the base component (110).

4. The device (100) of claim 1, wherein a material of the main pole (120) comprises metal.

5. The device (100) of claim 1, wherein the leg support pole (115) further comprises an auxiliary pole (117) extending from the leg support pole (115) at a right angle relative to the leg support pole (115).

6. The device (100) of claim 1, wherein the angle that the leg support pole (115) extends from the base component (110) is 30 to 60 degrees relative to the base component (110).

7. The device (100) of claim 1 further comprising a hand support pole (140) removably disposed on the main pole (120), extending at a 90 to 115 degree angle relative to the main pole (120).

8. The device (100) of claim 1, wherein each massage component (130) further comprises a cushion cover.

9. A configurable self-massaging device (100) comprising:
a. a main pole (120);
b. one or more vibrating massage components, wherein at least one vibrating massage component (130) of the one or more vibrating massage components are configured to be attached to a point on the main pole (130); and
c. a rotation component (150) coupled to the main pole (120), wherein the at least one massage component (130) attached to the main pole (120) is attached to the rotation component (150) by a rotational attachment component such that the at least one massage component (130) attached to the main pole (120) is configured to rotate on an axis defined by the rotational attachment component.

10. The device (100) of claim 9, wherein each vibrating massage component (130) comprises:
a. a cushion (131);
b. a vibration component (132) attached to the cushion (131), wherein actuating the vibration component (132) causes vibration of the cushion (131); and
c. an attachment component (133) configured to secure the massage component (130) to a point on a pole.

11. The device (100) of claim 9, wherein the at least one vibrating massage component (130) attached to the main pole (120) allows for massaging of a user's hands, wrists, back, buttocks, chest, face, neck, and head.

12. The device (100) of claim 9 further comprising:
a. a base component (110), wherein the main pole (120) extends vertically from the base component (110); and
b. a leg support pole (115) extending from the base component (110) at an angle relative to the base component (110).

13. The device (100) of claim 12, wherein a massage component (130) attached to the leg support pole (115) allows for massaging of a user's legs and feet.

14. The device (100) of claim 12, wherein the leg support pole (115) further comprises an auxiliary pole (117) extending from the leg support pole (115) at a right angle relative to the leg support pole (115).

15. The device (100) of claim 12, wherein the angle that the leg support pole (115) extends from the base component (110) is 30 to 60 degrees relative to the base component (110).

16. The device (100) of claim 12, wherein the main pole (120) is telescopically attached to the base component (110).

17. The device (100) of claim 9, wherein a material of the main pole (120) comprises metal.

18. The device (100) of claim 10, wherein each massage component (130) further comprises:
a. an additional cushion; and
b. an additional vibration component attached to the additional cushion, wherein actuating the additional vibration component causes vibration of the additional cushion.

19. The device (100) of claim 9 further comprising a hand support pole (140) removably disposed on the main pole (120), extending at a 90 to 115 degree angle relative to the main pole (120).

20. The device (100) of claim 10, wherein each vibrating massage component (130) further comprises a cushion cover configured to encapsulate the cushion (131).
